(19) United States
(12) Patent Application Publication
(10) Pub. No.: US 2018/0203988 A1
(43) Pub. Date: Jul. 19, 2018

(54) System and Method for Multiple Sequential Factor Authentication for Display Devices

(71) Applicant: DELL PRODUCTS, LP, Round Rock, TX (US)

(72) Inventors: Daniel L. Hamlin, Round Rock, TX (US); Charles D. Robison, Buford, GA (US); Yagiz C. Yildiz, Austin, TX (US)

(21) Appl. No.: 15/407,779

(22) Filed: Jan. 17, 2017

(51) Int. Cl. G06F 21/36; G06F 21/32; G06F 3/0481; G06F 3/0484

(52) U.S. Cl. CPC G06F 21/36; G06F 3/04845; G06F 3/04817; G06F 21/32

(57) ABSTRACT

An information handling system includes a display device and a processor configured to display a plurality of icons in a first display area, divide a second display area into a plurality of sectors, designate an authentication sector of the plurality of sectors, designate an authentication icon of the plurality of icons, receive a user input including selecting one of the icons and dragging the selected icon to a selected one of the sectors, determine if the selected sector is the authentication sector and if the selected icon is the authentication icon, and display a prompt to the user to provide an authentication factor to log on to the information handling system in response to the selected sector being the authentication sector and to the selected icon being the authentication icon.

### FIELD OF THE DISCLOSURE

This disclosure generally relates to information handling systems, and more particularly relates to multiple sequential factor authentication for display devices.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a display device and a processor. The processor may be configured to display a plurality of icons in a first display area, divide a second display area into a plurality of sectors, designate one of the sectors as an authentication sector, designate one of the icons as an authentication icon, receive a user input comprising selecting a second icon and dragging the second icon to a second sector, determine if the second sector is the authentication sector and if the first icon is the authentication icon, and display a prompt to the user to provide an authentication factor to log on to the information handling system in response to the second sector being the authentication sector and to the second icon being the authentication icon.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an authentication framework for an information handling system according to an embodiment of the present disclosure;

FIGS. 2 and 3 illustrate a display screen for providing a sector based authentication of a user on an information handling system according to an embodiment of the present disclosure;

FIGS. 4 and 5 illustrate a display screen for providing a sector based authentication of a user on an information handling system according to another embodiment of the present disclosure;

FIG. 6 is a flowchart illustrating a method for multiple sequential factor authentication for a display device according to an embodiment of the present disclosure; and

FIG. 7 is a block diagram illustrating a generalized information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

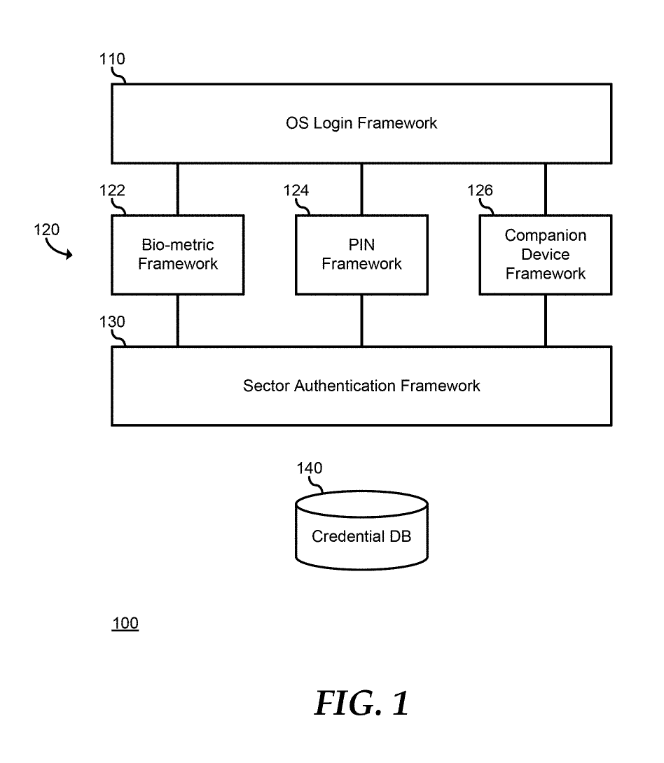

FIG. 1 illustrates an embodiment of an authentication framework 100 for an information handling system. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a laptop computer, a smart phone, a tablet device or other consumer electronic device, a network server, a network storage device, a switch router or other network communication device, or any other suitable device and may vary in size, shape, performance, functionality, and price. Further, an information handling system can include processing resources for executing machine-executable code, such as a central processing unit (CPU), a programmable logic array (PLA), an embedded device such as a System-on-a-Chip (SoC), or other control logic hardware. An information handling system can also include one or more computer-readable medium for storing machine-executable code, such as software or data. Additional components of an information handling system can include one or more storage devices that can store machine-executable code, one or more communications ports for communicating with external devices, and various input and output (I/O) devices, such as a keyboard, a mouse, and a video display. An information handling system can also include one or more buses operable to transmit information between the various hardware components.

Authentication framework 100 includes an operating system (OS) login framework 110, authentication mechanisms 120, a sector authentication framework 130, hardware drivers 140, and an authentication credential database 150. OS login framework 110 represents the elements of an operating system that are utilized in providing for login and logout services for an information handling system. In particular, OS login framework 110 operates to utilized the hardware, software, firmware, and other features of the information handling system to receive and authenticate authentication credentials provided by a user, and to launch an operating system session on behalf of an authenticated user to permit the user to utilized the functions and features of the information handling system.

In a particular embodiment, OS login framework 110 operates strictly within the confines of the information handling system, such that all of the information needed to authenticate a user resides on the information handling system, and the resources available to the authenticated user are limited to the confines of the information handling system. This does not preclude an authenticated user from authenticating onto resources outside of the information handling system, such as onto an external network, but here, such authentication may be performed separately by the user, such as by separately logging in to the external network. In this case, the act of authenticating a particular user may be limited to checking various authentication information provided by the user against corresponding authenticated information in authentication credential database 150.

In another embodiment, OS login framework 110 operates within a broader environment that includes the information handling system and other elements, and authentication of a user may necessitate various encryption and decryption activities, hashing activities, or other security measures to ensure the security of the login process, itself. For example, authentication of a user may necessitate a first level of authentication onto the information handling system that includes checking a portion of the authentication information provided by the user against corresponding authentication information in authentication credential database 150. The successful completion of the first level of authentication then enables a second level of authentication over a network where another portion of the authentication information provided by the user is checked against an Active Directory or another authentication service. In either embodiment, OS login framework 110 operates as gatekeeper to the functions and features of the information handling system, permitting access to the authenticated users and blocking access to users who are not authenticated. An example of OS login framework 110 includes a Microsoft Windows Hello security framework or another similar login framework, as needed or desired. Other aspects of the operation of OS login framework 110 in particular, and of other login frameworks generally, are known in the art, and will not be further discussed herein, except as described below.

Authentication mechanisms 120 include a biometric framework 122, a personal identification number (PIN) framework 124, and a companion device framework 126. Biometric framework 122 represents a device for scanning a particular biometric feature of a user, and converting the scan into an authentication token that can be authenticated against an associated token in authentication credential database 150 in order to verify the identity of the user as being authorized to utilize the functions and features of the information handling system. An example of a biometric framework includes a Microsoft Windows Biometric Framework (WBF) that operates to provide native support for various biometric devices in a Windows operating environment, various biometric scanning devices, such as a fingerprint scanner, a retinal scanner, or another scanning device, as needed or desired. PIN framework 124 operates to provide a visual prompt for the inputting of a PIN into a keypad device, a keyboard, a depiction of a keypad on a touch panel display device, or the like, for receiving the inputted PIN, for verifying the PIN with associated PIN information in authentication credential database 150, and for authenticating the user to utilize the functions and features of the information handling system. Companion device framework 126 operates to receive an authentication token from an authorized device, to verify the identity of the authorized device, and to open access to the functions and features of the information handling system based upon the verified identity of the device. For example, a user may have a device, such as a smart phone, a tablet device, a security enabled identification badge, or the like, which communicates an authentication token to the information handling system via a short range wireless communication channel such as a Bluetooth channel, a WiFi channel, of a personal area network (PAN) channel, via a RFID reader, or another communication channel, as needed or desired.

In a particular embodiment authentication mechanisms 120 each represent a particular authentication factor that can be utilized to provide a user with access to the functions and features of the information handling system. Typically, access to the functions and features of the information handling system may be granted to a user based upon one of an input provided to biometric framework 122, an input provided to PIN framework 124, and an input provided to companion device framework 126, and an input provided to OS login framework 110, or access may be granted based upon a combination of two or more authentication factors. Here, generally, when authentication is performed within a broader environment than the information handling system itself, the authentication information must be securely transmitted between the information handling system and the external authentication agents. For example, a username and password, a biometric token, a PIN, or a companion device identification may be encrypted prior to transmission to the external authentication agent, or a hash of such authentication information may be generated and transmitted to the external authentication agent for verification.

Such verification procedures as are provided by OS login framework 110 and authentication mechanisms 120 may be cumbersome to provide where access to a keyboard is limited, or may not provide a sufficient level of security to ensure that only authenticated users are permitted access to the functions and features of the information handling system. Sector authentication framework 130 provides an added authentication factor that is maintained within the confines of the information handling system. In particular, sector authentication framework 130 provides an authentication step that is performed by a user prior to the initiation of the authentication activities as described above with respect to OS login framework 110 and authentication mechanisms 120. Sector authentication framework 130 operates to provide a simple screen based authentication mechanism where a user selects a sector of a display screen prior to the initiation of the authentication activities as described above. Here, if the user selects a predetermined sector, then the user is prompted to provide the authentication credentials associated with one or more of OS login framework 110 and authentication mechanisms 120. If the user selects an incorrect sector, then no further authentication activities are performed until the correct sector. In order to prevent random selections from being used, sector authentication framework 130 also operates to maintain a count of incorrect sector selections and to lock down the information handling system from any further authentication requests when the number of incorrect sector selections exceeds a predetermined number. Thus sector authentication framework 130 provides a simple, local authentication step that provides added security to the information handling system. Also, sector authentication framework 130 is well adapted to touchscreen devices which may have limited access to other user interface peripherals, such as a keyboard or a mouse.

Authentication credential database 140 represents one or more secure resources, either included in the information handling system, or external to the information handling system, for storage and maintenance of authentication tokens, credentials, passwords, and the like. The authentication information stored in authentication credential database 140 is compared with the authentication information provided from OS login framework 110, authentication mechanisms 120, and sector authentication framework 130 in order to verify the identity of a user attempting to gain access to the functions and features of the information handling system. Note that, as used herein, a framework represents hardware, software, firmware, code, devices, or combination thereof which are configured to operate together to perform the operations, provide the functions, or implement the features as described in association with the framework.

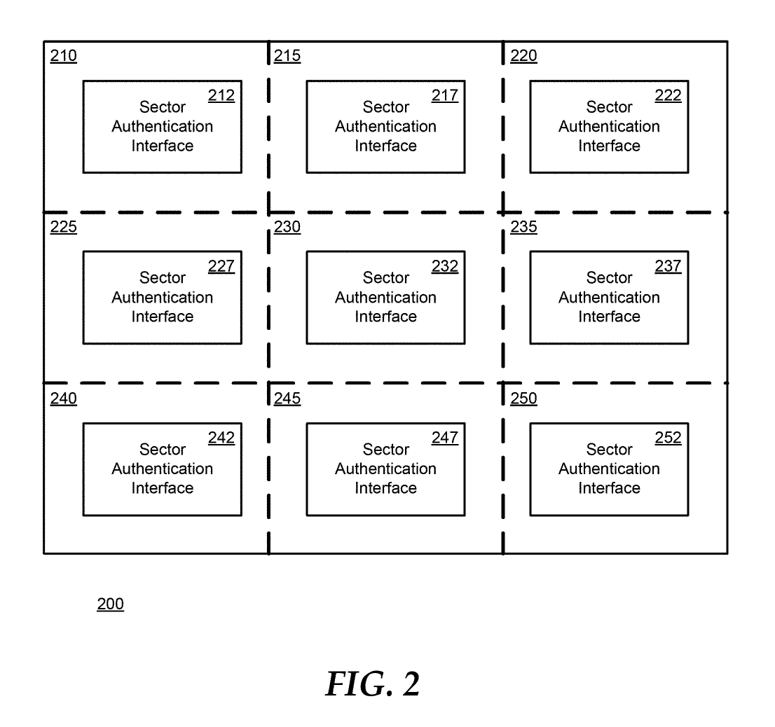

FIG. 2 illustrates a display screen 200 for providing a sector based authentication of a user on an information handling system that displays the display screen. Display screen 200 is divided into sectors 210-250. Each sector includes an associated sector authentication interface 212-252 which represents the area of display screen 200 that is utilized by the user to provide a selection of the associated sector. In a particular embodiment, display screen 200 represents an image on a display of the information handling system that is not a touchscreen display, and the display screen will also include a pointer, such as a cursor or mouse pointer, which the user can maneuver around the display screen and can make selections, such as by clicking a mouse button. In another embodiment, display screen 200 represents an image on a touchscreen display, and the user can directly interact with the display screen by touching a portion of the display screen.

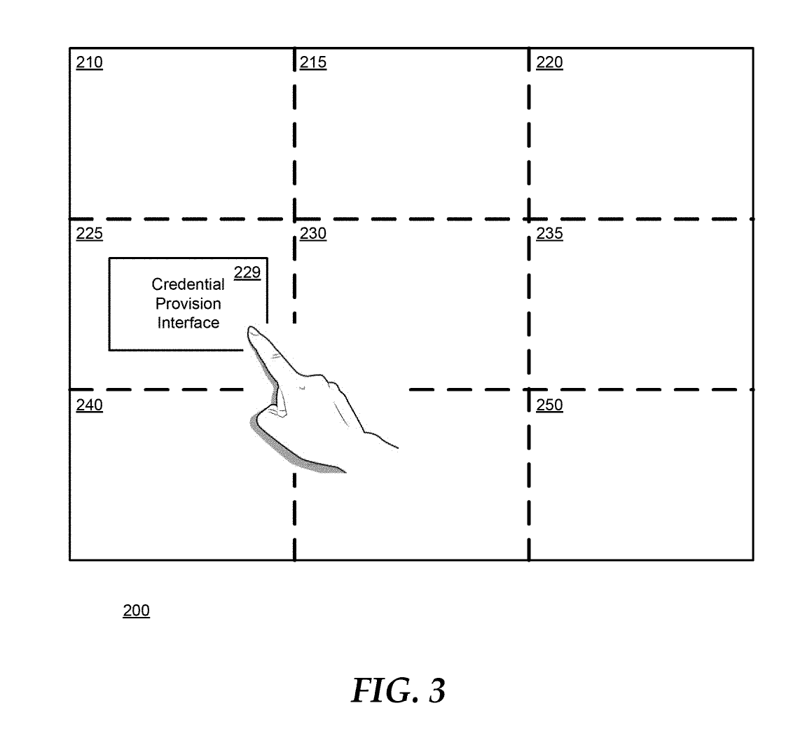

In either embodiment, a predetermined sector 210-250 can be designated as being associated with authenticating the user to proceed with further authentication activities, such as those represented by OS login framework 110 or authentication mechanisms 120 of FIG. 1, above. For example, sector 225 can be identified as the predetermined sector, such that, when a user selects sector 225, as shown in FIG. 3, sector authentication interface 227 is replaced with a credential provision interface 229, thereby indicating that the user correctly selected the predetermined sector. If the user selects any sector other than the predetermined sector 225, then no sector authentication interface is provided, and the user is not permitted to engage in any further authentication activities.

Note that display screen 200, as illustrated, includes dashed lines indicating the locations of sectors 210-250, but this is not necessarily so, and the sectors may be wholly defined by pixel locations in a display frame buffer that are each associated with a different sector. Moreover, sector authentication interfaces 212-252 are illustrated as boxes within their respective sectors, but this is not necessarily so, and each sector may provide the functions of the associated sector authentication interfaces without providing a visual reference as to the presence of the associated sector authentication interfaces. In other words, display screen 200 may be completely blank, or may display a photographic image or other information, as needed or desired, but may maintain the functions and features of being divided into sectors and providing sector authentication interfaces, without providing any visual clues as to the presence of the sectors or to the functions of the sector based authentication as described above. Note further that display screen 200 as illustrated includes nine sectors, but this is not necessarily so, and more sectors or fewer sectors may be provided, as needed or desired. In fact, the presence of a greater number of sectors may have the added benefit of ensuring that a guess by an unauthorized user is less likely to be a lucky guess of the predetermined sector. Further, note that display screen 200 as illustrated shows sectors that are equally sized and arranged on a grid, but this is not necessarily so, and other sector arrangements and sizes may be selected, as needed or desired. For example, a bulls-eye pattern of sectors could be utilized, sectors could be selected to roughly correspond with a photographic image displayed on display screen 200, or another arrangement of sectors could be selected, as needed or desired. Also note that, as illustrated, sector authentication interface 227 is shown within sector 225, but this is not necessarily so. In particular, it may be determined that providing a sector authentication interface within the correct sector provides too handy an indication as to which sector is the predetermined sector, such that a casual observer may determine which sector to select. As such, it may be preferable to provide the sector authentication interface in a generic location on the display screen, as needed or desired.

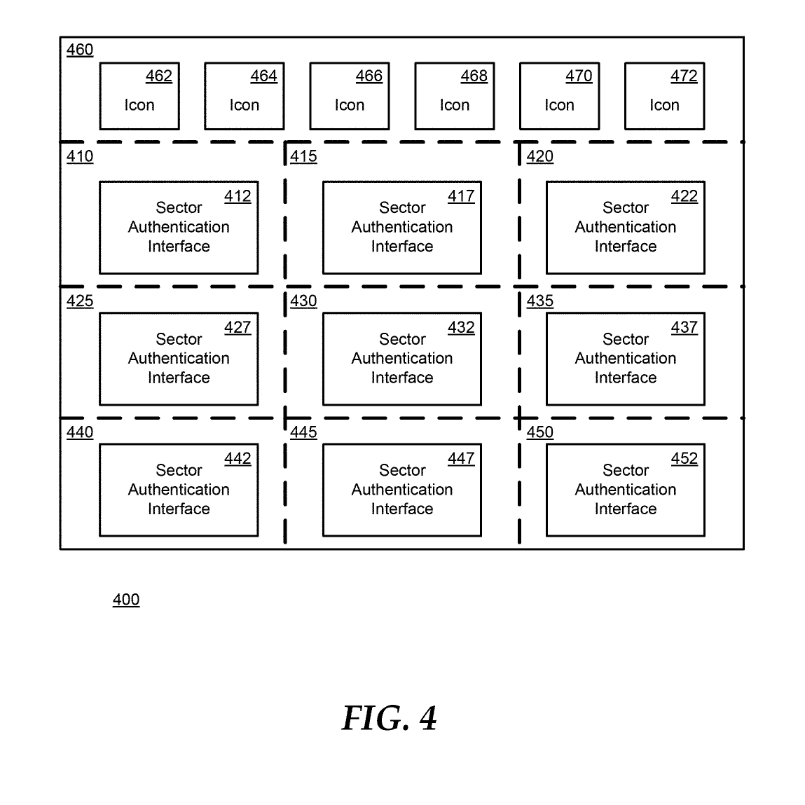

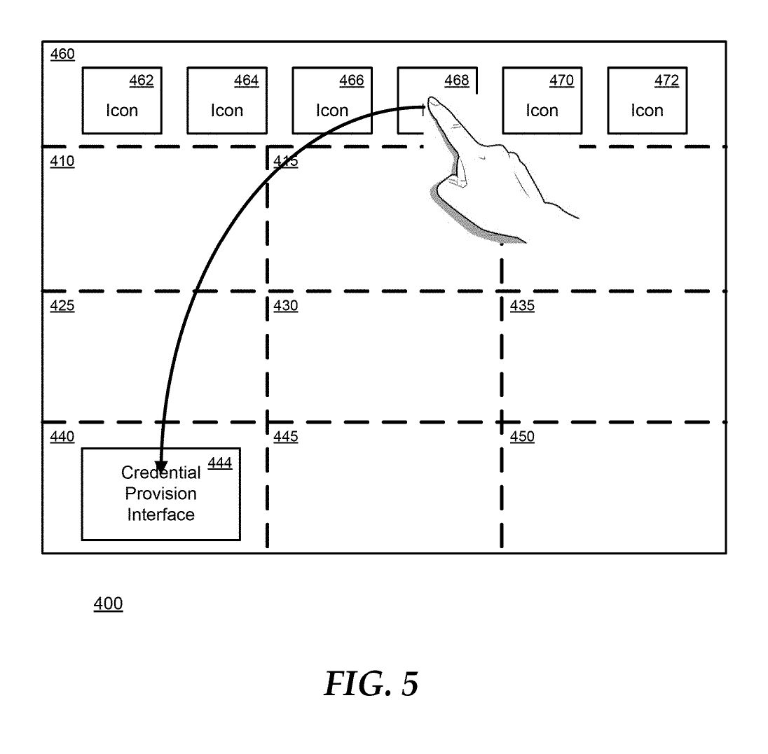

FIG. 4 illustrates a display screen 400 for providing a different embodiment of a sector based authentication of a user on an information handling system that displays the display screen. Display screen 400 is divided into sectors 410-450, similar to sectors 210-250. Each sector includes an associated sector authentication interface 412-452 which represents the area of display screen 400 that is utilized by the user to provide a selection of the associated sector. Display screen 400 also includes an icon panel 460 that displays icons 462-472. Here, in addition to designating a predetermined sector 410-450, one or more of icons 462-472 is also designated as a predetermined icon. Then, a user selects the predetermined icon and drags it to the predetermined sector in order to unlock the further authentication activities, such as those represented by OS login framework 110 or authentication mechanisms 120 of FIG. 1, above. For example, icon 468 can be identified as the predetermined icon and sector 440 can be identified as the predetermined sector, such that, when a user selects icon 468 and drags it to sector 440, as shown in FIG. 5, sector authentication interface 442 is replaced with a credential provision interface 444, thereby indicating that the user correctly selected the predetermined icon and sector. If the user selects any sector other than the predetermined sector 225, then no sector authentication interface is provided, and the user is not permitted to engage in any further authentication activities.

Note that display screen 400 may be provided in any manor, such as described with respect to display screen 200, above. For example, sectors may be wholly defined by pixel locations in a display frame buffer that are each associated with a different sector, and each sector may provide the functions of the associated sector authentication interfaces without providing a visual reference as to the presence of the associated sector authentication interfaces. Further, display screen 400 may include more sectors or fewer sectors than are illustrated, and other sector arrangements and sizes may be selected, as needed or desired. Also, the sector authentication interface does not need to be displayed in the associated sector.

In another embodiment, multiple icons 462-472 are identified and associated with one or more of sectors 410-450. Here, a user selects a first icon and drags it to a first sector, and then selects subsequent icons and drags them each to a sector. Here, the further authentication activities, such as those represented by OS login framework 110 or authentication mechanisms 120 of FIG. 1, above, are thus dependent upon providing a correct selection of icons to the correct associated sectors. In a particular embodiment, the order of execution of the dragging icons to sectors is considered, such that the combination created by the ordered set of icons and sectors is determinative. In another embodiment, the order of execution is not determinative, and the fact that the correct icons are dragged to the correct sectors is the only determinative factor. Note that here, as in the embodiments described above, the actual presence of a visual cue is not necessary for the functions and features described above to operate.

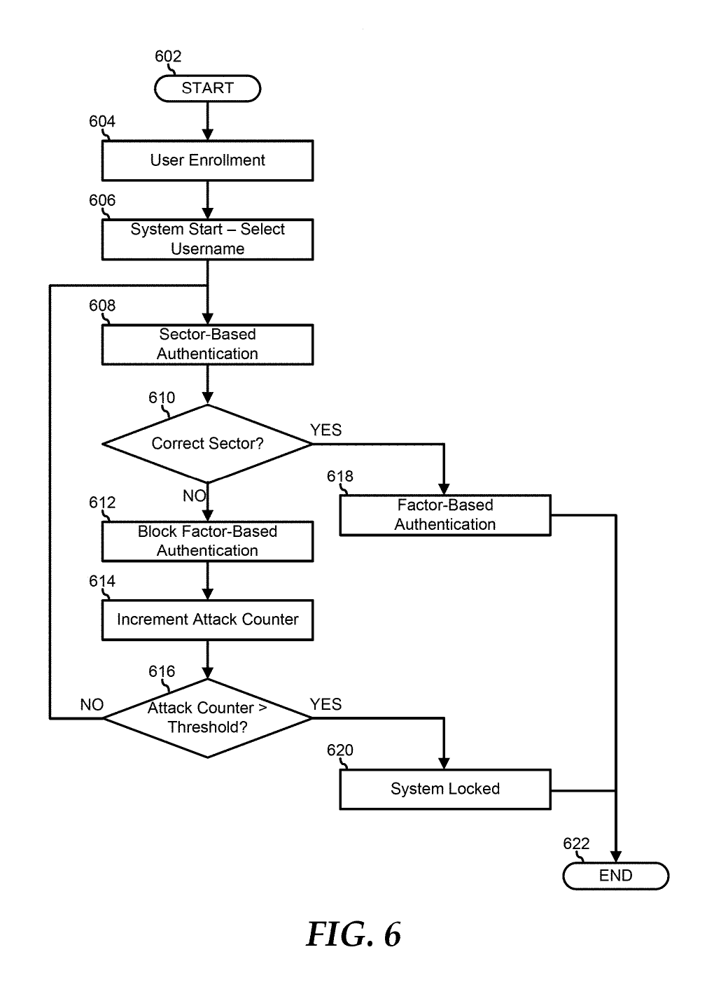

FIG. 6 illustrates a method for multiple sequential factor authentication for a display device starting at block 602. A user enrolls onto an information handling system in block 604. Here, a user can select a user name to be associated with an operating system session on the information handling system, and can provide information associated with various factor-based authentication activities, such as providing a password, providing a biometric scan, providing a PIN, associating a companion device with the information handling system, or a combination thereof. Such authentication information is stored in one or more authentication credential databases for use in providing authentication for the user onto the information handling system. The user can also select a method for providing sector-based authentication, such as by selecting a sector on a display screen, selecting one or more icons and associating each icon with a sector on the display screen, or other sector-based authentication information. Here, the factor-based authentication information and the sector based authentication information is associated with the user's user name.

The information handling system is started in block 606, when a user enters their user name into the information handling system. The user is prompted to provide sector-based authentication information to the information handling system in block 608. For example, the user can select a sector of a display screen that the user believes to be associated with the sector selected in block 604, above, or the user can select an icon that the user believes to be the correct icon, and can drag it to a sector that the user believes to be associated with the sector selected in block 604. A decision is made as to whether or not the sector-based authentication information was correctly selected in decision block 610. If so, the “YES” branch of decision block 610 is taken, the user is permitted to proceed with the various factor-based authentication in block 618, and the method ends in block 622.

If the sector-based authentication information was not correctly selected, the “NO” branch of decision block 610 is taken and the user is barred from proceeding with the various factor-based authentication in block 612. An attack counter is incremented based upon the incorrect provision of sector-based authentication information in block 614, and a decision is made as to whether or not an attack counter threshold has been exceeded in decision block 616. If so, the “YES” branch of decision block 616 is taken, the information handling system is locked from being utilized and further authentication activities are halted in block 620, and the method ends in block 622. If the attack counter threshold has not been exceeded, the “NO” branch of decision block 616 is taken and the method returns to block 608 where the sector-based authentication is retried.

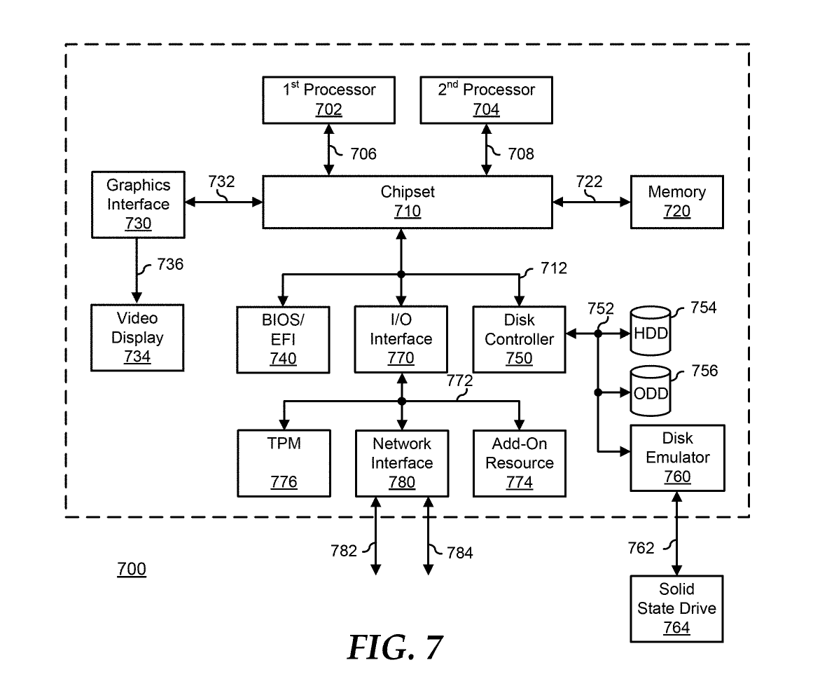

FIG. 7 illustrates a generalized embodiment of information handling system 700. For purpose of this disclosure information handling system 700 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 700 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 700 can include processing resources for executing machine-executable code, such as a central processing unit (CPU), a programmable logic array (PLA), an embedded device such as a System-on-a-Chip (SoC), or other control logic hardware. Information handling system 700 can also include one or more computer-readable medium for storing machine-executable code, such as software or data. Additional components of information handling system 700 can include one or more storage devices that can store machine-executable code, one or more communications ports for communicating with external devices, and various input and output (I/O) devices, such as a keyboard, a mouse, and a video display. Information handling system 700 can also include one or more buses operable to transmit information between the various hardware components.

Information handling system 700 can include devices or modules that embody one or more of the devices or modules described above, and operates to perform one or more of the methods described above. Information handling system 700 includes a processors 702 and 704, a chipset 710, a memory 720, a graphics interface 730, include a basic input and output system/extensible firmware interface (BIOS/EFI) module 740, a disk controller 750, a disk emulator 760, an input/output (I/O) interface 770, and a network interface 780. Processor 702 is connected to chipset 710 via processor interface 706, and processor 704 is connected to the chipset via processor interface 708. Memory 720 is connected to chipset 710 via a memory bus 722. Graphics interface 730 is connected to chipset 710 via a graphics interface 732, and provides a video display output 736 to a video display 734. In a particular embodiment, information handling system 700 includes separate memories that are dedicated to each of processors 702 and 704 via separate memory interfaces. An example of memory 720 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 740, disk controller 750, and I/O interface 770 are connected to chipset 710 via an I/O channel 712. An example of I/O channel 712 includes a Peripheral Component Interconnect (PCI) interface, a PCI-Extended (PCI-X) interface, a high speed PCI-Express (PCIe) interface, another industry standard or proprietary communication interface, or a combination thereof. Chipset 710 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 740 includes BIOS/EFI code operable to detect resources within information handling system 700, to provide drivers for the resources, initialize the resources, and access the resources. BIOS/EFI module 740 includes code that operates to detect resources within information handling system 700, to provide drivers for the resources, to initialize the resources, and to access the resources.

Disk controller 750 includes a disk interface 752 that connects the disc controller to a hard disk drive (HDD) 754, to an optical disk drive (ODD) 756, and to disk emulator 760. An example of disk interface 752 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 760 permits a solid-state drive 764 to be connected to information handling system 700 via an external interface 762. An example of external interface 762 includes a USB interface, an IEEE 1394 (Firewire) interface, a proprietary interface, or a combination thereof. Alternatively, solid-state drive 764 can be disposed within information handling system 700.

I/O interface 770 includes a peripheral interface 772 that connects the I/O interface to an add-on resource 774, to a TPM 776, and to network interface 780. Peripheral interface 772 can be the same type of interface as I/O channel 712, or can be a different type of interface. As such, I/O interface 770 extends the capacity of I/O channel 712 when peripheral interface 772 and the I/O channel are of the same type, and the I/O interface translates information from a format suitable to the I/O channel to a format suitable to the peripheral channel 772 when they are of a different type. Add-on resource 774 can include a data storage system, an additional graphics interface, a network interface card (NIC), a sound/video processing card, another add-on resource, or a combination thereof. Add-on resource 774 can be on a main circuit board, on separate circuit board or add-in card disposed within information handling system 700, a device that is external to the information handling system, or a combination thereof.

Network interface 780 represents a NIC disposed within information handling system 700, on a main circuit board of the information handling system, integrated onto another component such as chipset 710, in another suitable location, or a combination thereof. Network interface device 780 includes network channels 782 and 784 that provide interfaces to devices that are external to information handling system 700. In a particular embodiment, network channels 782 and 784 are of a different type than peripheral channel 772 and network interface 780 translates information from a format suitable to the peripheral channel to a format suitable to external devices. An example of network channels 782 and 784 includes InfiniBand channels, Fibre Channel channels, Gigabit Ethernet channels, proprietary channel architectures, or a combination thereof. Network channels 782 and 784 can be connected to external network resources (not illustrated). The network resource can include another information handling system, a data storage system, another network, a grid management system, another suitable resource, or a combination thereof.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a display device; and
a processor configured to:
display in a first display area of the display device a plurality of icons;
divide a second display area of the display device into a plurality of sectors;
designate a first one the sectors as a first authentication sector;
designate a first one of the icons as a first authentication icon;
receive a first user input on the display device, the first user input including selecting a second one of the icons and dragging the second icon to a second one of the sectors;
determine if the second sector is the first authentication sector and if the second icon is the first authentication icon; and
display a prompt to the user to provide an authentication factor to log on to the information handling system in response to the second sector being the first authentication sector and to the second icon being the first authentication icon.

2. The information handling system of claim 1, the processor further configured to:
designate a third one of the sectors as a second authentication sector;
designate a third one of the icons as a second authentication icon;
receive a second user input on the display device, the second user input comprising selecting a fourth one of the icons and dragging the fourth icon to a fourth one of the sectors; and
determine if the fourth sector is the second authentication sector and if the fourth icon is the second authentication icon;
wherein displaying the prompt is in further response to the fourth sector being the second authentication sector and to the fourth icon being the second authentication icon.

3. The information handling system of claim 1, the processor further configured to:
increment an attack counter in response to one of the second sector not being the first authentication sector and the second icon not being the first authentication icon.

4. The information handling system of claim 3, the processor further configured to:
determine if the attack counter is greater than an attack threshold.

5. The information handling system of claim 4, the processor further configured to:
lock the information handling system from further log in attempts in response to determining that the attack counter is greater than the attack threshold.

6. The information handling system of claim 1, the processor further configured to:
receive a second user input prior to receiving the first user input, the second user input comprising a user name.

7. The information handling system of claim 6, wherein the first authentication sector is determined based upon the user name.

8. The information handling system of claim 1, wherein the authentication factor comprises one of a username/password authentication, a bio-metric authentication, a Personal Identification Number (PIN) authentication, and a companion device authentication.

9. A method, comprising:
displaying, in a first display area of a display device, a plurality of icons;
dividing, by a processor, a second display area of the display device into a plurality of sectors;
designating a first one sector of the sectors as a first authentication sector;
determining a first one of the icons as a first authentication icon;
receiving a first user input on the display device, the first user input including selecting a second one of the icons and dragging the second icon to a second one of the sectors;
determining if the second sector is the first authentication sector and if the second icon is the first authentication icon; and
displaying, on the display device, a prompt to the user to provide an authentication factor to log on to an information handling system in response to the second sector being the first authentication sector and to the second icon being the first authentication icon.

10. The method of claim 9, further comprising:
designating a third one of the sectors as a second authentication sector;
designating a third one of the icons as a second authentication icon;
receiving a second user input on the display device, the second user input comprising selecting a fourth one of the icons and dragging the fourth icon to a fourth one of the sectors; and
determining if the fourth sector is the second authentication sector and if the fourth icon is the second authentication icon;
wherein displaying the prompt is in further response to the fourth sector being the second authentication sector and to the fourth icon being the second authentication icon.

11. The method of claim 9, further comprising:
incrementing an attack counter in response to one of the second sector not being the first authentication sector and the second icon not being the first authentication icon.

12. The method of claim 11, further comprising:
determining if the attack counter is greater than an attack threshold.

13. The method of claim 12, further comprising:
locking the information handling system from further log in attempts in response to determining that the attack counter is greater than the attack threshold.

14. The method of claim 9, further comprising:
receiving a second user input prior to receiving the first user input, the second user input comprising a user name.

15. The method of claim 14, wherein the authentication sector is determined based upon the user name.

16. The method of claim 9, wherein the authentication factor comprises one of a username/password authentication, a bio-metric authentication, a Personal Identification Number (PIN) authentication, and a companion device authentication.

17. An information handling system, comprising:
a display device; and
a processor configured to:
divide a display area of the display device into a plurality of sectors;
designate a first one of the sectors as an authentication sector;
receive a first user input on the display device, the first user input selecting a second one of the sectors;
determine if the second sector is the authentication sector; and
display a prompt to the user to provide an authentication factor to log on to the information handling system in response to the second sector being the authentication sector.

18. The information handling system of claim 17, the processor further configured to:
increment an attack counter in response to the second sector not being the authentication sector;
determine if the attack counter is greater than an attack threshold; and
lock the information handling system from further log in attempts in response to determining that the attack counter is greater than the attack threshold.

19. The information handling system of claim 17, the processor further configured to:
receive a second user input prior to receiving the first user input, the second user input comprising a user name, wherein the authentication sector is determined based upon the user name.

20. The information handling system of claim 17, wherein the authentication factor comprises one of a username/password authentication, a bio-metric authentication, a Personal Identification Number (PIN) authentication, and a companion device authentication.
